(19) United States
(12) Patent Application Publication
(10) Pub. No.: US 2025/0297093 A1
(43) Pub. Date: Sep. 25, 2025

(54) METHOD TO IMPROVE SURFACE GLOSS STABILITY OF ACRYLONITRILE-BUTADIENE-STYRENE COPOLYMER COMPOSITIONS

(71) Applicant: INEOS STYROLUTION GROUP GMBH, Frankfurt am Main (DE)

(72) Inventors: Norbert NIESSNER, Friedelsheim (DE); Oliver CARSTENSEN, Frankfurt (DE); Christian DIETLEIN, Wuerzburg (DE)

(21) Appl. No.: 18/866,772

(22) PCT Filed: May 16, 2023
(86) PCT No.: PCT/EP2023/063093

§ 371 Date: Nov. 18, 2024

(30) Foreign Application Priority Data
May 18, 2022 (EP) 22174141.6

(51) Int. Cl. C08L 55/02

(52) U.S. Cl. CPC C08L 55/02; C08L 2205/025; C08L 2207/20

(57) ABSTRACT

The invention relates to a method for providing an acrylonitrile-butadiene-styrene copolymer composition (ABS) with improved the surface gloss stability by admixing a virgin acrylonitrile-butadiene-styrene copolymer composition (v-ABS), with 10 to 99 wt.-%, based on the ABS, of at least one recycled acrylonitrile-butadiene-styrene copolymer composition (r-ABS), wherein the at least one recycled acrylonitrile-butadiene-styrene copolymer composition (r-ABS) has passed at least one separate thermal compounding step prior to the admixing step. Further disclosed is a process for preparing the ABS composition and the use of the ABS composition for preparing molding compositions.

The invention relates to a method for providing an acrylonitrile-butadiene-styrene copolymer composition (ABS) with improved the surface gloss stability, by admixing a virgin acrylonitrile-butadiene-styrene copolymer composition (v-ABS) with at least one recycled acrylonitrile-butadiene-styrene copolymer composition (r-ABS).

Acrylonitrile-butadiene-styrene (ABS) copolymer compositions are known for decades and commonly used for consumer articles. It is known that ABS with high surface gloss can be obtained by using rubber particles having an average particle diameter at or below the wavelength of visible light. While mass-polymerized ABS (with particles sizes typically from 300 nm to 5 μm) tends to show only low surface gloss, emulsion-polymerized ABS (with particles sizes typically from 100 nm to 400 nm) show a higher surface gloss (see Practical Guide to Structures, Properties and Applications of Styrenic Polymers; N. Niessner, D. Wagner; Smithers, 2013).

In practical applications, it is important to retain gloss levels of ABS, even after use at elevated temperatures over a long time span. Well-established methods to improve surface gloss retention are the use of antioxidants and/or secondary stabilizer(s), e.g. sulfur and/or phosphite containing components. Such solutions are complex and might not be economically feasible.

KR 2010-0122303 discloses ABS compositions with good gloss properties comprising 100 parts by weight of thermoplastic ABS base resin, and 0.01 to 0.5 pbw of modified acrylic copolymer. The base resin includes 25 to 40 wt.-% of ABS copolymer with a conjugated diene-based rubber copolymer grafted with a vinyl aromatic compound and vinyl cyanide; 10 to 45 wt.-% of copolymer of the vinyl cyanide and the vinyl aromatic compound; and 25 to 50 wt.-% of recycled thermosetting resin.

WO 2021/110751 (INEOS Styrolution) discloses thermoplastic molding compositions comprising a recycled polymer material A containing recycled acrylonitrile-butadiene-styrene copolymer (r-ABS) as component A1, a graft copolymer A different from A and at least one block copolymer C. The document relates to a process for the preparation of the thermoplastic molding composition, the use of it for preparing a shaped article and a shaped article prepared. WO 2021/074084 (INEOS Styrolution) reports that the addition of at least two different virgin materials is required to adjust the properties of recycled ABS (r-ABS) in such way that the blends obtained are within a pre-defined corridor of mechanical, thermal and flow properties. It was found that the addition of at least two virgin materials selected from acrylonitrile-butadiene-styrene copolymers (ABS), styrene-acrylonitrile copolymers (SAN), styrene-butadiene block copolymers (SBC) and lubricants is advantageous to obtain a recycled ABS product with high and consistent quality having a good balance of the required properties.

The prior art fails to disclose methods to improve the surface gloss stability of molded ABS parts after prolonged storage at high temperature. It was now surprisingly found that the surface gloss stability of ABS compositions can be significantly improved by admixing recycled ABS to a virgin ABS composition. Despite a higher initial gloss level of the virgin ABS composition compared the recycled ABS, after 1000 hours at 80° C. the gloss level of blends of recycled ABS with the virgin ABS is higher than that of the pure virgin ABS.

### DESCRIPTION OF THE INVENTION

The present invention is directed to a method for improving the surface gloss stability of an acrylonitrile-butadiene-styrene copolymer composition (ABS) by admixing a virgin acrylonitrile-butadiene-styrene copolymer composition (v-ABS), with 10 to 99 wt.-%, based on the acrylonitrile-butadiene-styrene copolymer composition, of at least one recycled acrylonitrile-butadiene-styrene copolymer composition (r-ABS), wherein the at least one recycled acrylonitrile-butadiene-styrene copolymer composition (r-ABS) has passed at least one separate thermal compounding step prior to the admixing step, wherein the virgin acrylonitrile-butadiene-styrene copolymer composition (v-ABS) is a virgin material comprising:
A: 20 to 60 wt.-% of at least one graft copolymer A, comprising (or consisting of):
   A1: 40 to 85 wt.-%, based on the solids content of the graft copolymer A, of a graft substrate A1, comprising:
      A11: 0 to 21 wt.-%, based on the graft substrate A1, of at least one vinylaromatic monomer, in particular styrene, and
      A12: 79 to 100 wt.-%, based on the graft substrate A1, of butadiene,
      wherein A11 and A12 sum to 100 wt.-% of the graft substrate A1; and
   A2: 15 to 60 wt.-%, based on the solids content of the graft copolymer A, of at least one graft sheath A2 comprising:
      A21: 70 to 90 wt.-%, based on the graft sheath A2, of styrene and/or α-methylstyrene, in particular styrene, and
      A22: 10 to 30 wt.-%, based on the graft sheath A2, of acrylonitrile,
      wherein A21 and A22 sum to 100 wt.-% of the graft sheath A2; and
   where the graft substrate A1 and the graft sheath A2 sum to 100 wt.-% graft copolymer A;
B: 40 to 80 wt.-% of at least one thermoplastic copolymer B obtainable from:
   B1: 20 to 31 wt.-%, based on the copolymer B, of acrylonitrile, and
   B2: 69 to 80 wt.-%, based on the copolymer B, of styrene or α-methylstyrene or a mixture of styrene and α-methylstyrene;
   wherein 1 and B2 sum to 100 wt.-% of the thermoplastic copolymer B; and
C: 0 to 5 wt.-% of at least one additive C;
wherein A, B and C sum to 100 wt.-% of the virgin acrylonitrile-butadiene-styrene copolymer composition (v-ABS).

In particular, the method of the present invention provides a post-consumer recycling product with improved gloss stability based on ABS copolymers and a method for its preparation.

In terms of the present invention, the terms “virgin material” or “virgin acrylonitrile-butadiene-styrene copolymer (v-ABS)” refer to a material, which is made from geological resources (e.g. oil based), and is not made from existing and in particular used material. In terms of the present invention, virgin polymer material means a polymer, which is made from geological resources, such as petroleum, and is not made from existing and in particular used plastic material.

In terms of the present invention, the term “recycled material” or “recycled acrylonitrile-butadiene-styrene copolymer (r-ABS)” refers to a polymer from the type of acrylonitrile-butadiene-styrene copolymer that is prepared from waste plastic material, in particular from recycled durable goods, typically in a recycling and separation process. The recycled acrylonitrile-butadiene-styrene copolymer composition (r-ABS) has passed at least one separate thermal compounding step prior to the admixing step, such as e.g. an extrusion process or an injection-molding process.

In terms of the present invention “durable goods” or “recycled durable goods” means goods, such as household appliance, machinery, sport equipment, consumer electronics, and automobiles, that are not consumed or destroyed quickly in use, but are expected to last and yields utility a long time, in particular three or more years. In particular, the term “post-consumer products” or “post-consumer durable goods” refer to products or goods after their intended use, in particular after their use for three or more years, e.g. such material is collected and recycled in form of waste plastic material.

Preferably, the method comprises the process step of admixing the virgin acrylonitrile-butadiene-styrene copolymer composition (v-ABS) with 10 to 99 wt.-%, more preferably 30 to 89 wt.-%, for example 40 to 80 wt.-% or 45 to 75 wt.-%, often 50 to 70 wt.-%, based on the acrylonitrile-butadiene-styrene copolymer composition (ABS), of a recycled acrylonitrile-butadiene-styrene copolymer composition (r-ABS).

It was surprisingly found that by admixing a virgin acrylonitrile-butadiene-styrene copolymer composition (v-ABS), with 10 to 99 wt.-% of at least one recycled acrylonitrile-butadiene-styrene copolymer composition (r-ABS), the optical properties of the obtained acrylonitrile-butadiene-styrene copolymer composition (ABS) are superior compared to the pure virgin acrylonitrile-butadiene-styrene copolymer composition (v-ABS) as well as to the pure recycled acrylonitrile-butadiene-styrene copolymer composition (r-ABS). In particular, surface gloss, gloss stability and visual appearance after artificial weathering are improved.

According to the invention, the gloss stability is preferably determined by comparing the gloss of a surface of a molded article formed from the acrylonitrile-butadiene-styrene copolymer composition (ABS) before and after aging at 80° C. for 1000 h with the gloss of a surface of a molded article formed from the virgin acrylonitrile-butadiene-styrene copolymer composition (v-ABS).

The constituents v-ABS and r-ABS are described in further detail in the following section.

Virgin acrylonitrile-butadiene-styrene copolymer (v-ABS)

According to the invention, the method employs virgin acrylonitrile-butadiene-styrene copolymer composition (v-ABS) which is a virgin material comprising:
A: 20 to 60 wt.-% of at least one graft copolymer A, comprising:
   A1: 40 to 85 wt.-%, based on the solids content of the graft copolymer A, of a graft substrate A1, comprising:
      A11: 0 to 21 wt.-%, based on the graft substrate A1, of at least one vinylaromatic monomer, in particular styrene, and
      A12: 79 to 100 wt.-%, based on the graft substrate A1, of butadiene,
      wherein A11 and A12 sum to 100 wt.-% of the graft substrate A1; and
   A2: 15 to 60 wt.-%, based on the solids content of the graft copolymer A, of at least one graft sheath A2 comprising:
      A21: 70 to 90 wt.-%, based on the graft sheath A2, of styrene and/or α-methylstyrene, in particular styrene, and
      A22: 10 to 30 wt.-%, based on the graft sheath A2, of acrylonitrile,
      wherein A21 and A22 sum to 100 wt.-% of the graft sheath A2; and
   where the graft substrate A1 and the graft sheath A2 sum to 100 wt.-% graft copolymer A;
B: 40 to 80 wt.-% of at least one thermoplastic copolymer B obtainable from:
   B1: 20 to 31 wt.-%, based on the copolymer B, of acrylonitrile, and
   B2: 69 to 80 wt.-%, based on the copolymer B, of styrene or α-methylstyrene or a mixture of styrene and α-methylstyrene;
   wherein B1 and B2 sum to 100 wt.-% of the thermoplastic copolymer B.

Said virgin acrylonitrile-butadiene-styrene copolymer composition (v-ABS) is principally known in the art and described in the literature, e.g. in
Graft copolymer A is typically comprising:
A1: 40 to 85 wt.-%, based on the solids content of the graft copolymer A, of a graft substrate A1 obtainable by polymerizing:
   A11: 0 to 21 wt.-%, based on the graft substrate A1, of at least one vinylaromatic monomer, in particular styrene, and
   A12: 79 to 100 wt.-%, based on the graft substrate A1, of at least one diene, in particular butadiene,
   where A11 and A12 sum to 100 wt.-%; and
   agglomerating the obtained graft substrate A1 using an agglomerating agent C; and
A2: 15 to 60 wt.-%, based on the solids content of the graft copolymer A, of a graft sheath obtainable by reacting the agglomerated graft substrate A1 with a mixture of:
   A21: 70 to 90 wt.-%, based on the graft sheath A2, of styrene and/or α-methylstyrene, in particular styrene, and
   A22: 10 to 30 wt.-%, based on the graft sheath A2, of acrylonitrile and/or methyl methacrylate, in particular acrylonitrile;
      where the graft substrate A1 and the graft sheath A2 sum to 100 wt.-% of the graft copolymer A.

The graft substrate A1 generally employs the diene component A12 in an amount of from 79 to 100 wt.-%, preferably 90 to 98 wt.-%, and the vinylaromatic component A11 in an amount of from 0 to 21 wt.-%, preferably 2 to 10 wt.-%.

The component A11 employed may be alpha-methylstyrene and/or styrene, preferably only styrene. The diene component A12 employed may be for example isoprene and/or butadiene, preferably butadiene.

Preference is given to a graft substrate A1 composed of butadiene and styrene in the abovementioned composition.

The graft substrate A1 is preferably prepared by emulsion polymerization and the agglomerated by an agglomerating agent C. Processes for preparing the suitable graft substrates A1 are known in the art and described, for example, in DE 10 2005 022 632 or WO 2014/170406.

The obtained dispersion of the agglomerated graft substrate A1 is relatively stable and may be readily stored and transported without onset of visible coagulation. The agglomerated graft substrate A1 is used to produce graft copolymers A.

To produce the graft copolymers A, the agglomerated graft substrate A1 is grafted with at least one graft sheath A2 comprising the monomers A21 and A22.

The graft copolymer A generally comprises 40 to 85 wt.-%, based on the solids content of the graft copolymer A, of a graft substrate A1 and 15 to 60 wt.-%, based on the solids content of the graft copolymer A, of a graft sheath A2. A1 and A2 sum to 100 wt.-%.

The graft sheath A2 may be obtained by reaction of:
A21: 70 to 90 wt.-%, preferably 75 to 85 wt.-%, of styrene and/or α-methylstyrene, in particular styrene, and
A22: 10 to 30 wt.-%, preferably 15 to 25 wt.-%, of acrylonitrile, methacrylonitrile and/or methyl methacrylate, in particular acrylonitrile, in the presence of the agglomerated graft substrate A1. A21 and A22 sum to 100 wt.-%.

Preferred graft sheaths A2 are constructed from A2-1 copolymers of styrene and acrylonitrile, A2-2 copolymers of α-methylstyrene and acrylonitrile. Particular preference is given to A2-1 copolymers of styrene and acrylonitrile. Particularly preferred graft sheaths A2 are obtained by reaction of from 75 to 85 wt.-% of styrene and from 15 to 25 wt.-% of acrylonitrile.

The graft sheath A2 is preferably prepared by an emulsion polymerization process after performing the agglomeration of the graft substrate A1.

Preferably, the virgin ABS (v-ABS) comprises graft copolymers A having a particle size distribution having a D₅₀ in the range from 70 nm to 550 nm, preferably 80 nm to 450 nm, often 100 nm to 400 nm.

The weight median particle size D₅₀ is the diameter, which divides the population exactly into two equal parts. 50 wt.-% of the particles are larger than the weight median particle size D₅₀ and 50 wt.-% are smaller. The weight median particle size D₅₀ value can be determined using a ultracentrifuge (for example as described in W. Scholtan, H. Lange: Kolloid Z. u. Z. Polymere 250, pp. 782 to 796 (1972)) or a disc centrifuge (for example DC 24000 by CPS Instruments Inc.).

Particulars pertaining to the performance of the graft reaction are known to those skilled in the art and are disclosed, for example, in DE-A 24 27 960, EP-A 0062901 or WO 2014/170406 (see “Pfropfcopolymer B, Allgemeine Vorgehensweise”, pp 34-35).

Preference is given to graft copolymers A obtained from:
A1: 40 to 85 wt.-%, based on the solids content of the graft copolymer A, of a graft substrate A1 obtainable by
   (a) polymerizing:
   A11: 0 to 21 wt.-%, based on the graft substrate A1, of styrene, and
   A12: 79 to 100 wt.-%, based on the graft substrate A1, of butadiene,
   where A11 and A12 sum to 100 wt.-%; and
   (b) agglomerating the obtained graft substrate A1 by adding
   C: 0.01 to 5 parts by weight, based on 100 parts by weight of the graft substrate A1, in each case based on the solids content, of an agglomerating copolymer C of:
      C1: 80 to 99.9 wt.-% of ethyl acrylate and
      C2: 0.1 to 20 wt.-% of methacrylamide,
      where C1 and C2 sum to 100 wt.-%; and
A2: 15 to 60 wt.-%, based on the solids content of the graft copolymer A, of a graft sheath obtainable by reacting the agglomerated graft substrate A1 with a mixture of:
   A21 70 to 90 wt.-%, based on the graft sheath A2, of styrene, and
   A22 10 to 30 wt.-%, based on the graft sheath A2, of acrylonitrile,
      where the graft substrate A1 and the graft sheath A2 sum to 100 wt.-% in total based on the graft copolymer A.

The thermoplastic copolymer B is preferably produced from components acrylonitrile and styrene and/or α-methylstyrene by bulk polymerization or in presence of one or more solvents. Preference is given to copolymers B having weight-average molar masses Mw of from 50,000 to 300,000 g/mol, where the weight molar masses may be determined, for example, by means of GPC with tetrahydrofuran as solvent and with UV detection. The thermoplastic copolymer B forms the thermoplastic matrix of the virgin acrylonitrile-butadiene-styrene copolymer composition (v-ABS). The number-averaged molar masses (Mn) of the copolymer B is preferably from 15,000 to 100,000 g/mol (determined by GPC with tetrahydrofuran as solvent and with UV detection). The viscosity of the copolymer B (determined according to DIN 53726 at 25° C. in a 0.5 wt.-% solution in DMF) is, for example, from 50 to 120 ml/g.

The thermoplastic copolymer B may in particular comprise or consist of:
(Ba) poly(styrene-acrylonitrile), produced from 69 to 80 wt.-% of styrene and 20 to 31 wt.-% of acrylonitrile, each based on the total weigh of (Ba), or
(Bb) poly(α-methylstyrene-acrylonitrile), produced from 69 to 80 wt.-% of α-methylstyrene and 20 to 31 wt.-% of acrylonitrile, each based on the total weigh of (Bb), or
(Bc) a mixture of the copolymer matrix (Ba) and the copolymer matrix (Bb).

The thermoplastic copolymer B may also be obtained by copolymerization of acrylonitrile, styrene and α-methylstyrene. However, it is also possible in principle to employ polymer matrices containing further monomer building blocks.

The thermoplastic copolymer B may e.g. be produced by bulk polymerization/solution polymerization, for example, in toluene or ethylbenzene according to a process such as is described, for example, in Kunststoff-Handbuch, Vieweg-Daumiller, Vol V, (Polystyrol), Carl-Hanser-Verlag, Munich 1969, pages 122 f., lines 12 ff.

As previously described hereinabove the preferred copolymer component B is a poly(styrene-acrylonitrile), poly(α-methylstyrene-acrylonitrile) or mixtures thereof. In a preferred embodiment, after production the component B is isolated according to processes known to those skilled in the art and preferably processed into pellets.

The virgin acrylonitrile-butadiene-styrene copolymer composition (v-ABS) may comprise up to 5 wt.-%, preferably up to 3 wt.-%, based on the total virgin acrylonitrile-butadiene-styrene copolymer composition (v-ABS), of one or more additional additive C. Preferably, the virgin acrylonitrile-butadiene-styrene copolymer composition (v-ABS) may comprise from 0.01 to 5 wt.-%, preferably 0.1 to 2.5 wt.-%, based on the total virgin acrylonitrile-butadiene-styrene copolymer composition (v-ABS), of one or more additives C.

The additive C is typically selected from commonly known additives for styrene polymers and copolymers and compositions thereof which are customarily employed for processing or finishing the polymers.

Examples include, for example, dyes, pigments, colorants, antistatic agents, antioxidants, stabilizers for improving thermal stability, stabilizers for increasing photostability, stabilizers for enhancing hydrolysis resistance and chemical resistance, anti-thermal decomposition agents and in particular lubricants that are useful for production of molded bodies/articles. These further added substances may be admixed at any stage of the manufacturing operation, but preferably at an early stage in order to profit early on from the stabilizing effects (or other specific effects) of the added substance. For further customary assistants and added substances, see, for example, “Plastics Additives Handbook”, Ed. Gächter and Müller, 4th edition, Hanser Publ., Munich, 1996.

Examples of suitable pigments include titanium dioxide, phthalocyanines, ultramarine blue, iron oxides or carbon black, and also the entire class of organic pigments.

Examples of suitable colorants include all dyes that may be used for the transparent, semi-transparent, or non-transparent coloring of polymers, in particular those suitable for coloring styrene copolymers.

Examples of suitable flame retardants that may be used include the halogen-containing or phosphorus-containing compounds known to the person skilled in the art, magnesium hydroxide, and also other commonly used compounds, or mixtures thereof.

Examples of suitable antioxidants include sterically hindered monocyclic or polycyclic phenolic antioxidants which may comprise various substitutions and may also be bridged by substituents. These include not only monomeric but also oligomeric compounds, which may be constructed of a plurality of phenolic units. Hydroquinones and hydroquinone analogs are also suitable, as are substituted compounds, and also antioxidants based on tocopherols and derivatives thereof. It is also possible to use mixtures of different antioxidants. It is possible in principle to use any compounds which are customary in the trade or suitable for styrene copolymers, for example antioxidants from the Irganox range. In addition to the phenolic antioxidants cited above by way of example, it is also possible to use so-called co-stabilizers, in particular phosphorus- or sulfur-containing co-stabilizers. These phosphorus- or sulfur-containing co-stabilizers are known to those skilled in the art.

Examples of suitable light stabilizers include various substituted resorcinols, salicylates, benzotriazoles and benzophenones.

Suitable matting agents include not only inorganic substances such as talc, glass beads or metal carbonates (for example MgCO₃, CaCO₃) but also polymer particles, in particular spherical particles having diameters D₅₀ greater than 1 μm, based on, for example, methyl methacrylate, styrene compounds, acrylonitrile or mixtures thereof. It is further also possible to use polymers comprising copolymerized acidic and/or basic monomers.

Examples of suitable antidrip agents include polytetrafluoroethylene (Teflon) polymers and ultrahigh molecular weight polystyrene (weight-average molar mass Mw above 2,000,000).

Examples of fibrous/pulverulent fillers include carbon or glass fibers in the form of glass fabrics, glass mats, or filament glass rovings, chopped glass, glass beads, and wollastonite, particular preference being given to glass fibers. When glass fibers are used, they may be finished with a sizing and a coupling agent to improve compatibility with the blend components. The glass fibers incorporated may either take the form of short glass fibers or else continuous filaments (rovings).

Examples of suitable particulate fillers include carbon black, amorphous silica, magnesium carbonate, powdered quartz, mica, bentonites, talc, feldspar or, in particular, calcium silicates, such as wollastonite, and kaolin.

Examples of suitable antistatic agents include amine derivatives such as N,N-bis(hydroxyalkyl)alkylamines or -alkyleneamines, polyethylene glycol esters, copolymers of ethylene oxide glycol and propylene oxide glycol (in particular two-block or three-block copolymers of ethylene oxide blocks and propylene oxide blocks), and glycerol mono- and distearates, and mixtures thereof.

Examples of suitable stabilizers include hindered phenols but also vitamin E/compounds having analogous structures and also butylated condensation products of p-cresol and dicyclopentadiene. HALS stabilizers (Hindered Amine Light Stabilizers), benzophenones, resorcinols, salicylates, benzotriazoles are also suitable. Other suitable compounds include, for example, thiocarboxylic esters. Also usable are C₆-C₂₀ alkyl esters of thiopropionic acid, in particular the stearyl esters and lauryl esters. It is also possible to use the dilauryl ester of thiodipropionic acid (dilauryl thiodipropionate), the distearyl ester of thiodipropionic acid (distearyl thiodipropionate) or mixtures thereof.

Examples of further additives include HALS absorbers, such as bis(2,2,6,6-tetramethyl-4-piperidyl) sebacate or UV absorbers such as 2H-benzotriazol-2-yl-(4-methylphenol). Such additives are typically used in amounts of from 0.01 to 2 wt.-%, based on the total virgin acrylonitrile-butadiene-styrene copolymer composition (v-ABS).

Suitable lubricants and demolding agents include stearic acids, stearyl alcohol, stearic esters, amide waxes (bis-stearylamide), polyolefin waxes and/or generally higher fatty acids, derivatives thereof and corresponding fatty acid mixtures. Also particularly suitable is ethylene-bis-stearamide. The amounts of these additives are preferably in the range of from 0.05 to 5 wt.-%, based on the total virgin acrylonitrile-butadiene-styrene copolymer composition (v-ABS). Preferred lubricants may be selected from long-chain fatty acids, such as stearic acid or behenic acid, salts of fatty acids (e.g. calcium stearate or zinc stearate), esters of fatty acids (e.g. stearyl stearate or pentaerythrityl tetrastearate), amide derivatives of fatty acids (e.g. ethylenebisstearylamide, erucamide, Acrawax®), phosphates (such as tricalcium phosphate), hydrocarbon waxes, such as microcrystalline waxes and paraffin waxes (e.g. Besquare®), and fumed silica (e.g. Aerosil®). Typically, fatty acids are carboxylic acids having a linear or branched, saturated or unsaturated C₅-C₂₅ alkyl chain.

Also suitable additives are silicone oils, oligomeric isobutylene or similar substances. Typical amounts, when employed, are from 0.001 to 3 wt.-%, based on the total virgin acrylonitrile-butadiene-styrene copolymer composition (v-ABS).

An example of a processing aid, which can be used in amounts from 0.1 to 5 wt.-%, preferably from 0.5 to 3 wt.-%, based on the total virgin acrylonitrile-butadiene-styrene copolymer composition (v-ABS), is a homogeneously miscible oil or oil mixture, in particular selected from mineral oils (medical grade mineral oil), vegetable oils (also referred to as plant oils) and silicon oils.

Processing assistants and stabilizers such as UV stabilizers, heat stabilizers (for example butylated reaction products of p-cresol and dicyclopentadiene, Wingstay L from Omnova, or else the dilauryl ester of thiodipropionic acid, Irganox PS 800 from BASF), lubricants and antistatic agents (for example ethylene oxide-propylene oxide copolymers such as Pluronic from BASF), when employed, are typically used in amounts of from 0.01 to 5 wt.-%, based on the total virgin acrylonitrile-butadiene-styrene copolymer composition (v-ABS).

The individual added substances are generally used in the respective customary amounts.

Recycled Acrylonitrile-Butadiene-Styrene Copolymer (r-ABS)

Preferably, the recycled acrylonitrile-butadiene-styrene copolymer (r-ABS) is a recycled material obtained from the recycling of durable goods, in particular of post-consumer durable goods, preferably selected from automobile equipment, household appliance and electrical equipment.

Typically, durable goods are being understood as goods, such as household appliance, machinery, sport equipment, consumer electronics, and automobiles, that are not consumed or destroyed quickly in use, but are expected to last and yields utility a long time, in particular three or more years.

Preferably, the recycled acrylonitrile-butadiene-styrene copolymer (r-ABS) comprises at least 90 wt.-%, based on r-ABS, of acrylonitrile-butadiene-styrene copolymer type polymers. The recycled acrylonitrile-butadiene-styrene copolymer (r-ABS) can for example be a mixture of different grades of acrylonitrile-butadiene-styrene copolymers or the r-ABS component can be composed of one grade of r-ABS. For example, the r-ABS component can be obtained from scrap and rejected parts from a manufacturing process of ABS-molded articles.

In a preferred embodiment, the at least one recycled acrylonitrile-butadiene-styrene copolymer composition (r-ABS) is a recycled material comprising (or consisting of):
E: at least one acrylonitrile-butadiene-styrene copolymer E;
F: at least one styrene-acrylonitrile copolymer F; and
G: optionally at least one additive G.

Often, the at least one recycled acrylonitrile-butadiene-styrene copolymer composition (r-ABS) is a recycled material comprising (or consisting of):
E: 20 to 60 wt.-% of at least one graft copolymer E, comprising:
   E1: 40 to 85 wt.-%, based on the solids content of the graft copolymer E, of a graft substrate A1, comprising:
      E11: 0 to 21 wt.-%, based on the graft substrate E1, of at least one vinylaromatic monomer, in particular styrene, and
      E12: 79 to 100 wt.-%, based on the graft substrate E1, of butadiene, wherein E11 and E12 sum to 100 wt.-% of the graft substrate E1; and
   E2: 15 to 60 wt.-%, based on the solids content of the graft copolymer E, of at least one graft sheath E2 comprising:
      E21: 70 to 90 wt.-%, based on the graft sheath E2, of styrene and/or α-methylstyrene, in particular styrene, and
      E22: 10 to 30 wt.-%, based on the graft sheath E2, of acrylonitrile and optionally methyl methacrylate, in particular acrylonitrile,
      wherein E21 and E22 sum to 100 wt.-% of the graft sheath E2; and
   where the graft substrate E1 and the graft sheath E2 sum to 100 wt.-% graft copolymer E;
F: 40 to 80 wt.-% of at least one thermoplastic copolymer F obtainable from:
   F1: 20 to 31 wt.-%, based on the copolymer F, of acrylonitrile, and
   F2: 69 to 80 wt.-%, based on the copolymer F, of styrene or α-methylstyrene or a mixture of styrene and α-methylstyrene;
   wherein F1 and F2 sum to 100 wt.-% of the thermoplastic copolymer F; and
G: 0 to 5 wt.-% of at least one further additive G;
wherein E, F and G sum to 100 wt.-% of the recycled acrylonitrile-butadiene-styrene copolymer composition (r-ABS).

For the preferred embodiments of components E, F, E1, E2, E11, E12, E21, E22, F1 and F2, the definitions of components A, B, A1, A2, A11, A12, A21, A22, B1 and B2, apply respectively. However, the recycled acrylonitrile-butadiene-styrene copolymer composition (r-ABS) and the virgin acrylonitrile-butadiene-styrene copolymer composition (v-ABS) may be the same or different from each other from the viewpoint of its chemical composition.

The additional additive G typically represents commonly known additives for styrene polymers and copolymers and compositions thereof. Substances that can be present as additives or auxiliaries are the polymer additives known to the person skilled in the art and described as additives C herein above.

### Acrylonitrile-Butadiene-Styrene Copolymer Composition (ABS)

As previously described, the present invention relates to method for improving the surface gloss stability of an acrylonitrile-butadiene-styrene copolymer composition (ABS) by admixing a virgin acrylonitrile-butadiene-styrene copolymer composition (v-ABS), with 10 to 99 wt.-%, based on the acrylonitrile-butadiene-styrene copolymer composition (ABS), of at least one recycled acrylonitrile-butadiene-styrene copolymer composition (r-ABS), wherein the at least one recycled acrylonitrile-butadiene-styrene copolymer composition (r-ABS) has passed at least one separate thermal compounding step prior to the admixing step.

According to one aspect of the invention, the invention also relates to an acrylonitrile-butadiene-styrene copolymer composition (ABS) with improved gloss stability, comprising:
v-ABS: 1 to 90 wt.-%, preferably 11 to 70 wt.-%, more preferably 20 to 60 wt.-%, often 25 to 55 wt.-% or 30 to 50 wt.-%, based on the acrylonitrile-butadiene-styrene copolymer composition (ABS), of at least one virgin acrylonitrile-butadiene-styrene copolymer composition (v-ABS);
r-ABS: 10 to 99 wt.-%, preferably 30 to 89 wt.-%, more preferably 40 to 80 wt.-%, often 45 to 75 wt.-% or 50 to 70 wt.-%, based on the acrylonitrile-butadiene-styrene copolymer composition (ABS), of at least one recycled acrylonitrile-butadiene-styrene copolymer composition (r-ABS);
K: 0 to 10 wt.-%, of at least one additive K;
P: 0 to 15 wt.-%, preferably 0 to 10 wt.-%, more preferably 0 to 5 wt.-%, based on the acrylonitrile-butadiene-styrene copolymer composition (ABS), of at least one further polymer P different from the virgin acrylonitrile-butadiene-styrene copolymer composition (v-ABS) and the recycled acrylonitrile-butadiene-styrene copolymer composition (r-ABS);
wherein (v-ABS), (r-ABS), K and P sum to 100 wt.-% of the virgin acrylonitrile-butadiene-styrene copolymer composition (v-ABS), and
wherein the virgin acrylonitrile-butadiene-styrene copolymer composition (v-ABS) is a virgin material comprising:
A: 20 to 60 wt.-% of at least one graft copolymer A, comprising:
   A1: 40 to 85 wt.-%, based on the solids content of the graft copolymer A, of a graft substrate A1, comprising:
      A11: 0 to 21 wt.-%, based on the graft substrate A1, of at least one vinylaromatic monomer, in particular styrene, and
      A12: 79 to 100 wt.-%, based on the graft substrate A1, of butadiene, wherein A11 and A12 sum to 100 wt.-% of the graft substrate A1; and
   A2: 15 to 60 wt.-%, based on the solids content of the graft copolymer A, of at least one graft sheath A2 comprising:
      A21: 70 to 90 wt.-%, based on the graft sheath A2, of styrene and/or α-methylstyrene, in particular styrene, and
      A22: 10 to 30 wt.-%, based on the graft sheath A2, of acrylonitrile and optionally methyl methacrylate, in particular acrylonitrile,
   wherein A21 and A22 sum to 100 wt.-% of the graft sheath A2; and
   where the graft substrate A1 and the graft sheath A2 sum to 100 wt.-% graft copolymer A;
B: 40 to 80 wt.-% of at least one thermoplastic copolymer B obtainable from
   B1: 20 to 31 wt.-%, based on the copolymer B, of acrylonitrile, and
   B2: 69 to 80 wt.-%, based on the copolymer B, of styrene or α-methylstyrene or a mixture of styrene and α-methylstyrene;
   wherein B1 and B2 sum to 100 wt.-% of the thermoplastic copolymer B; and
C: 0 to 5 wt.-% of at least one additive C,
wherein A, B and C sum to 100 wt.-% of the virgin acrylonitrile-butadiene-styrene copolymer composition (v-ABS).

The components v-ABS, r-ABS, A, B, A1, A2, A11, A12, A21, A22, B1, and B2 and their preferred embodiments are as defined herein above.

The inventive acrylonitrile-butadiene-styrene copolymer composition (ABS) may comprise commonly known additives C as constituent of the virgin acrylonitrile-butadiene-styrene copolymer v-ABS). Suitable additives C are described herein above. Moreover, the inventive acrylonitrile-butadiene-styrene copolymer composition (ABS) may comprise commonly known additives G which originate from the recycled acrylonitrile-butadiene-styrene copolymer (r-ABS), but which are not included in the amount described for additive C. Additives G may be selected from the additive C described herein above. Additives G may be the same or different from the additives C.

Moreover, if deemed necessary, the acrylonitrile-butadiene-styrene copolymer composition (ABS) may comprise up to 10 wt.-%, preferably up to 5 wt.-%, based on the total acrylonitrile-butadiene-styrene copolymer composition (ABS), of one or more additional additive K, which does not originate from the v-ABS or the r-ABS. Preferably, the acrylonitrile-butadiene-styrene copolymer composition (ABS) may comprise from 0.01 to 10 wt.-%, preferably 0.1 to 5, more preferably 0.1 to 2.5 wt.-%, based on the total acrylonitrile-butadiene-styrene copolymer composition (ABS), of one or more additives C, G and K in total. The additional additive K is typically selected from commonly known additives for styrene polymers and copolymers and compositions thereof. Substances that can be used as additive K are polymer additives known to the person skilled in the art and described as additives C herein above. The individual added substances are generally used in the respective customary amounts.

The acrylonitrile-butadiene-styrene copolymer composition (ABS) may further comprise up to 15 wt.-%, preferably up to 10 wt.-%, more preferably up to 5 wt.-%, based on the total acrylonitrile-butadiene-styrene copolymer composition (ABS), of one or more additional polymer(s) P, which is different from the v-ABS and the r-ABS. The polymer P typically originates from the recycled acrylonitrile-butadiene-styrene copolymer composition (r-ABS) since it is often difficult to obtain recycled polymer materials with a purity of 100 wt.-% or close to 100 wt.-%.

Preferably, the acrylonitrile-butadiene-styrene copolymer composition (ABS) may comprise from 0.01 to 15 wt.-%, preferably 0.1 to 10 wt.-%, more preferably 0.1 to 5 wt.-%, based on the total acrylonitrile-butadiene-styrene copolymer composition (ABS), of one or more polymers P.

Preferably, the acrylonitrile-butadiene-styrene copolymer composition (ABS) comprises less than 5 wt.-%, preferably less than 2 wt.-%, more preferably less than 1 wt.-%, based on the total acrylonitrile-butadiene-styrene copolymer composition (ABS), of one or more polymers P.

Typical examples of polymers P include polyolefins, polycarbonates, polyester carbonates, polyesters, polyamides, polyoxyalkylenes, polyarylene sulfides, polyether ketones, polyvinyl chlorides and mixtures thereof.

Process for preparing the acrylonitrile-butadiene-styrene copolymer compositions (ABS) Furthermore, the present invention is directed to a process for preparing the inventive acrylonitrile-butadiene-styrene copolymer composition (ABS). In particular, the invention is directed to a process for preparing the inventive acrylonitrile-butadiene-styrene copolymer composition (ABS) as described above, wherein the components v-ABS, r-ABS and optionally K and/or P, are melt compounded at a temperature in the range of 180 to 280° C., preferably 200 to 250° C.

The acrylonitrile-butadiene-styrene copolymer composition (ABS) may be prepared by processes known per se. For example extruders, such a co-rotating or counter rotating single- or twin screw extruders, or other conventional kneading apparatuses, such as continuous or batch kneaders, Brabender mixers or Banbury mixers, may be used for preparing the acrylonitrile-butadiene-styrene copolymer composition (ABS).

Said kneading elements should ensure sufficient homogenization of the components guaranteeing micro mixing. The inventive acrylonitrile-butadiene-styrene copolymer composition (ABS) may be obtained by mixing and homogenization the components v-ABS, r-ABS and optionally K and/or P described above by the usual methods of plastic technology, wherein the sequence of adding the components may be varied.

Preferably, the recycled ABS component (r-ABS) may be pre-treated before the melt compounding with virgin ABS component (v-ABS), e.g. via homogenization, grinding, crushing, and/or micronization.

Use of the acrylonitrile-butadiene-styrene copolymer compositions (ABS) Further, the present invention is directed to the use of the inventive acrylonitrile-butadiene-styrene copolymer composition (ABS) described above for the preparation of molded articles (sharped articles) for various applications, e.g. applications in automotive sector, electronics, household articles, constructions, healthcare articles, packaging, sports and leisure articles. The acrylonitrile-butadiene-styrene copolymer composition (ABS) of the invention can be used for the production of molded articles of any type. These can be produced via injection molding, extrusion and blow molding processes. Another type of processing is the production of molded articles via thermoforming from sheets or films previously produced, and the process of film-overmolding. In particular, the inventive acrylonitrile-butadiene-styrene copolymer composition (ABS) is used in an injection molding process. Examples of these molded articles are films, profiles, housing parts of any type, e.g. for household devices such as juice presses, coffee machines, mixers; for office equipment such as monitors, printers, copiers; exterior and interior parts of automobiles; sheets, pipes, electrical installation ducts, windows, doors and other profiles for the construction sector (fitting-out of interiors and outdoor applications), and also parts for electrical and electronic uses, such as switches, plugs and sockets.

Molded articles made from the acrylonitrile-butadiene-styrene copolymer compositions (ABS)

Further, the present invention is directed to molded articles made of the inventive acrylonitrile-butadiene-styrene copolymer composition (ABS) described above. The molded articles can be selected from molded articles of any type, for example as described above. In particular, the molded articles can be for example parts for the fitting-out of interiors of rail vehicles, ships, aircraft, buses and other motor vehicles, bodywork components for motor vehicles, housings of electrical equipment containing small transformers, housings for equipment for the processing and transmission of information, housings and cladding for medical equipment, massage equipment and housings therefor, toy vehicles for children, sheet-like wall elements, housings for safety equipment, thermally insulated transport containers, apparatus for the keeping or care of small animals, molded articles for sanitary and bath equipment, protective grilles for ventilator openings, molded articles for garden sheds and tool sheds, housings for garden equipment.

The invention is further illustrated by the following examples and claims.

### Examples

ABS copolymer compositions according to Table 1 were prepared by co-extrusion of the components r-ABS and v-ABS.

v-ABS is a polymer blend comprising about 67 wt.-% of SAN-matrix (Mw ca. 135.000 g/mol) and about 27 to 32 wt.-% of a ABS-copolymer with a bimodal rubber particle size distribution. Both components were prepared by polymerization processes of INEOS Styrolution. The v-ABS product further contains additives, such as stabilizers, waxes and lubricants.

r-ABS is a copolymer blend obtained from the recycling of post-consumer goods.

TABLE 1
Sample ABS compositions

| Sample | r-ABS | v-ABS |
|---|---|---|
| Comparative Example 1 | 0 | 100 |
| Example 1 | 50 | 50 |
| Example 2 | 70 | 30 |
| Comparative Example 2 | 100 | 0 |

Several sample plaques of ABS were injection molded at mass temperature of T=250° C. to obtain high gloss stepped polymer plates (120 mm×60 mm).

The sample plaques were subjected to artificial ageing under heat-treatment in an oven at 80° C. For the evaluation of optical changes, the injection-molded stepped plates were stored in the oven for 1000 h. Optical properties of the sample plaques were determined according to the following conditions:
Color measurement:
Colorimeter: X-Rite Ci7860 benchtop spectrophotometer
Measurement geometry: d:8°, reflectance measurement with specular confinement (SCI)
Aperture: Ø 25 mm; Illuminant: D65; Observer: 10°
Output of color values: CIE L*a*b*
Gloss measurement:
Colorimeter: BYK Instruments spectro-guide 45/0 gloss
Measurement geometry: 45° c.:0°, reflection measurement+60° gloss measurement
Aperture: 11 mm Illuminant: D65; Observer: 10°, Output of gloss values: GU

The results found are summarized in the following Table 2.

TABLE 2
Optical properties after artificial aging.

| | | | | | Gloss |
|---|---|---|---|---|---|
| | | | | | difference |
| | Aging | | | | between |
| | time | Gloss | L* value | Visual | 0 and |
| Sample | [h] | (%) | (CIELAB) | impression | 1000 hr |
| Comparative | 0 | 96.9 | 28.37 | No color | 4.17 |
| Example 1 | 1000 | 92.73 | 28.50 | change | |
| Example 1 | 0 | 96.03 | 28.91 | No color | 3.00 |
| | 1000 | 93.03 | 27.99 | change | |
| Example 2 | 0 | 95.83 | 28.95 | No color | 2.61 |
| | 1000 | 93.22 | 28.73 | change | |
| Comparative | n.d. | n.d. | n.d. | Color | n.d. |
| Example 2 | | | | fluctuations | |
| | | | | visible | |

The visual impression was determined by visual inspection of the sample plaques by naked human eye. It was observed that the compositions of Examples 1 and 2 according to the invention as well as the composition of Comparative Example 1 exhibit no color change throughout the visible surface of the sample plaques. By contrast, the composition of Comparative Example 2 exhibited color fluctuations. Such color fluctuations make these compositions not advantageous for many applications.

As can be seen from the data given in Table 2, the use of blends of virgin ABS and recycled ABS improve the gloss stability of the surface of the high gloss sample plaques, in particular during thermal storage for 1000 hours at 80° C. in a heating oven (i.e. the gloss difference decreases).

This shows that the use of recycled ABS material contributes to the reduction of changes in the optical impression of the ABS surface in practice and in particular under continuous thermal stress compared to pure virgin ABS compositions. This can also be seen after more than 42 days of thermal treatment.

The molded articles made from such compositions have advantages properties and can be produced at low cost. They are ecologically advantageous.

1-15. (canceled)

16. A method for improving the surface gloss stability of an acrylonitrile-butadiene-styrene copolymer composition (ABS) by admixing a virgin acrylonitrile-butadiene-styrene copolymer composition (v-ABS), with 10 to 99 wt.-%, based on the acrylonitrile-butadiene-styrene copolymer composition (ABS), of at least one recycled acrylonitrile-butadiene-styrene copolymer composition (r-ABS),
wherein the at least one recycled acrylonitrile-butadiene-styrene copolymer composition (r-ABS) has passed at least one separate thermal compounding step prior to the admixing step, wherein the virgin acrylonitrile-butadiene-styrene copolymer composition (v-ABS) is a virgin material comprising:
A: 20 to 60 wt.-% of at least one graft copolymer A, comprising:
A1: 40 to 85 wt.-%, based on the solids content of the graft copolymer A, of a graft substrate A1, comprising:
A11: 0 to 21 wt.-%, based on the graft substrate A1, of at least one vinylaromatic monomer, and
A12: 79 to 100 wt.-%, based on the graft substrate A1, of butadiene,
wherein A11 and A12 sum to 100 wt.-% of the graft substrate A1; and
A2: 15 to 60 wt.-%, based on the solids content of the graft copolymer A, of at least one graft sheath A2 comprising:
A21: 70 to 90 wt.-%, based on the graft sheath A2, of styrene and/or α-methylstyrene, and
A22: 10 to 30 wt.-%, based on the graft sheath A2, of acrylonitrile,
wherein A21 and A22 sum to 100 wt.-% of the graft sheath A2; and
wherein the graft substrate A1 and the graft sheath A2 sum to 100 wt.-% of the graft copolymer A;
B: 40 to 80 wt.-% of at least one thermoplastic copolymer B obtainable from
B1: 20 to 31 wt.-%, based on the copolymer B, of acrylonitrile, and
B2: 69 to 80 wt.-%, based on the copolymer B, of styrene or α-methylstyrene or a mixture of styrene and α-methylstyrene;
wherein B1 and B2 sum to 100 wt.-% of the thermoplastic copolymer B;
and
C: 0 to 5 wt.-% of at least one additive C;
wherein the virgin acrylonitrile-butadiene-styrene copolymer composition (v-ABS) comprises at least one graft copolymer A having a particle size distribution having a weight median particle size D₅₀ in the range from 70 nm to 550 nm, and
wherein A, B and C sum to 100 wt.-% of the virgin acrylonitrile-butadiene-styrene copolymer composition (v-ABS).

17. The method for improving the surface gloss stability of an acrylonitrile-butadiene-styrene copolymer composition (ABS) according to claim 16, wherein the method comprises admixing the virgin acrylonitrile-butadiene-styrene copolymer composition (v-ABS) with 30 to 89 wt.-%, based on the acrylonitrile-butadiene-styrene copolymer composition (ABS), of the at least one recycled acrylonitrile-butadiene-styrene copolymer composition (r-ABS).

18. The method for improving the surface gloss stability of an acrylonitrile-butadiene-styrene copolymer composition (ABS) according to claim 16, wherein the method comprises admixing the virgin acrylonitrile-butadiene-styrene copolymer composition (v-ABS) with 40 to 80 wt.-%, based on the acrylonitrile-butadiene-styrene copolymer composition (ABS), of the at least one recycled acrylonitrile-butadiene-styrene copolymer composition (r-ABS).

19. The method for improving the surface gloss stability of an acrylonitrile-butadiene-styrene copolymer composition (ABS) according to claim 16, wherein the at least one recycled acrylonitrile-butadiene-styrene copolymer composition (r-ABS) is a recycled material comprising:
E: at least one acrylonitrile-butadiene-styrene copolymer E;
F: at least one styrene-acrylonitrile copolymer F; and
G: optionally at least one additive G.

20. The method for improving the surface gloss stability of an acrylonitrile-butadiene-styrene copolymer composition (ABS) according to claim 16, wherein the at least one recycled acrylonitrile-butadiene-styrene copolymer composition (r-ABS) is a recycled material comprising:
E: 20 to 60 wt.-% of at least one graft copolymer E, comprising:
E1: 40 to 85 wt.-%, based on the solids content of the graft copolymer E, of a graft substrate E1, comprising:
E11: 0 to 21 wt.-%, based on the graft substrate E1, of at least one vinylaromatic monomer, and
E12: 79 to 100 wt.-%, based on the graft substrate E1, of butadiene,
wherein E11 and E12 sum to 100 wt.-% of the graft substrate E1; and
E2: 15 to 60 wt.-%, based on the solids content of the graft copolymer E, of at least one graft sheath E2 comprising:
E21: 70 to 90 wt.-%, based on the graft sheath E2, of styrene and/or α-methylstyrene, and
E22: 10 to 30 wt.-%, based on the graft sheath E2, of acrylonitrile and optionally methyl methacrylate,
wherein E21 and E22 sum to 100 wt.-% of the graft sheath E2; and
wherein the graft substrate E1 and the graft sheath E2 sum to 100 wt.-% of the graft copolymer E;
F: 40 to 80 wt.-% of at least one thermoplastic copolymer F obtainable from:
F1: 20 to 31 wt.-%, based on the copolymer F, of acrylonitrile, and
F2: 69 to 80 wt.-%, based on the copolymer F, of styrene or α-methylstyrene or a mixture of styrene and α-methylstyrene;
wherein F1 and F2 sum to 100 wt.-% of the thermoplastic copolymer F; and
G: 0 to 5 wt.-% of at least one further additive G;
wherein E, F and G sum to 100 wt.-% of the at least one recycled acrylonitrile-butadiene-styrene copolymer composition (r-ABS).

21. The method for improving the surface gloss stability of an acrylonitrile-butadiene-styrene copolymer composition (ABS) according to claim 16, wherein the gloss stability is determined by comparing the gloss of a surface of a molded article formed from the acrylonitrile-butadiene-styrene copolymer composition (ABS) before and after aging at 80° C. for 1000 h with the gloss of a surface of a molded article formed from the virgin acrylonitrile-butadiene-styrene copolymer composition (v-ABS).

22. An acrylonitrile-butadiene-styrene copolymer composition (ABS) with improved gloss stability, comprising:
v-ABS: 1 to 90 wt.-%, based on the acrylonitrile-butadiene-styrene copolymer composition (ABS), of at least one virgin acrylonitrile-butadiene-styrene copolymer composition (v-ABS);
r-ABS: 10 to 99 wt.-%, based on the acrylonitrile-butadiene-styrene copolymer composition (ABS), of at least one recycled acrylonitrile-butadiene-styrene copolymer composition (r-ABS);
K: 0 to 8 wt.-%, of at least one additive K;
P: 0 to 15 wt.-%, based on the acrylonitrile-butadiene-styrene copolymer composition (ABS), of at least one further polymer different from the virgin acrylonitrile-butadiene-styrene copolymer composition (v-ABS) and the recycled acrylonitrile-butadiene-styrene copolymer composition (r-ABS);
wherein (v-ABS), (r-ABS), K and P sum to 100 wt.-% of the acrylonitrile-butadiene-styrene copolymer composition (ABS), and
wherein the virgin acrylonitrile-butadiene-styrene copolymer composition (v-ABS) is a virgin material comprising:
A: 20 to 60 wt.-% of at least one graft copolymer A, comprising:
A1: 40 to 85 wt.-%, based on the solids content of the graft copolymer A, of a graft substrate A1, comprising:
A11: 0 to 21 wt.-%, based on the graft substrate A1, of at least one vinylaromatic monomer, and
A12: 79 to 100 wt.-%, based on the graft substrate A1, of butadiene,
wherein A11 and A12 sum to 100 wt.-% of the graft substrate A1; and
A2: 15 to 60 wt.-%, based on the solids content of the graft copolymer A, of at least one graft sheath A2 comprising:
A21: 70 to 90 wt.-%, based on the graft sheath A2, of styrene and/or α-methylstyrene, and
A22:10 to 30 wt.-%, based on the graft sheath A2, of acrylonitrile and optionally methyl methacrylate,
wherein A21 and A22 sum to 100 wt.-% of the graft sheath A2; and
where the graft substrate A1 and the graft sheath A2 sum to 100 wt.-% graft copolymer A;
B: 40 to 80 wt.-% of at least one thermoplastic copolymer B obtainable from
B1: 20 to 31 wt.-%, based on the copolymer B, of acrylonitrile, and
B2: 69 to 80 wt.-%, based on the copolymer B, of styrene or α-methylstyrene or a mixture of styrene and α-methylstyrene;
wherein B1 and B2 sum to 100 wt.-% of the thermoplastic copolymer B; and
C: 0 to 5 wt.-% of at least one additive C,
wherein A, B and C sum to 100 wt.-% of the virgin acrylonitrile-butadiene-styrene copolymer composition (v-ABS), and
wherein the virgin acrylonitrile-butadiene-styrene copolymer composition (v-ABS) comprises at least one graft copolymer A having a particle size distribution having a weight median particle size D₅₀ in the range from 70 nm to 550 nm.

23. The acrylonitrile-butadiene-styrene copolymer composition (ABS) according to claim 22, wherein the at least one recycled acrylonitrile-butadiene-styrene copolymer composition (r-ABS) is a recycled material obtained from the recycling of durable goods.

24. The acrylonitrile-butadiene-styrene copolymer composition (ABS) according to claim 22, wherein the at least one recycled acrylonitrile-butadiene-styrene copolymer composition (r-ABS) is a recycled material comprising:
E: 20 to 60 wt.-% of at least one graft copolymer E, comprising:
E1: 40 to 85 wt.-%, based on the solids content of the graft copolymer E, of a graft substrate E1, comprising:
E11: 0 to 21 wt.-%, based on the graft substrate E1, of at least one vinylaromatic monomer, and
E12: 79 to 100 wt.-%, based on the graft substrate E1, of butadiene,
wherein E11 and E12 sum to 100 wt.-% of the graft substrate E1; and
E2: 15 to 60 wt.-%, based on the solids content of the graft copolymer E, of at least one graft sheath E2 comprising:
E21: 70 to 90 wt.-%, based on the graft sheath E2, of styrene and/or α-methylstyrene, and
E22: 10 to 30 wt.-%, based on the graft sheath E2, of acrylonitrile and optionally methyl methacrylate,
wherein E21 and E22 sum to 100 wt.-% of the graft sheath E2; and
where the graft substrate E1 and the graft sheath E2 sum to 100 wt.-% of the graft copolymer E;
F: 40 to 80 wt.-% of at least one thermoplastic copolymer F obtainable from:
F1: 20 to 31 wt.-%, based on the copolymer F, of acrylonitrile, and
F2: 69 to 80 wt.-%, based on the copolymer F, of styrene or α-methylstyrene or a mixture of styrene and α-methylstyrene;
wherein F1 and F2 sum to 100 wt.-% of the thermoplastic copolymer F;
and
G: 0 to 5 wt.-% of at least one further additive G,
wherein E, F and G sum to 100 wt.-% of the recycled acrylonitrile-butadiene-styrene copolymer composition (r-ABS).

25. A process for preparing an acrylonitrile-butadiene-styrene copolymer composition (ABS) according to claim 22, wherein the at least one virgin acrylonitrile-butadiene-styrene copolymer composition (v-ABS), the at least one recycled acrylonitrile-butadiene-styrene copolymer composition (r-ABS) and optionally the at least one additive K and/or the at least one further polymer P are melt compounded at a temperature in the range of 180 to 280° C.

26. A molded article made of the acrylonitrile-butadiene-styrene copolymer composition (ABS) according to claim 22.

27. A process for the production of a molded article according to claim 26, the process comprising injection molding processes, extrusion processes, blow molding processes, thermoforming processes and/or film-overmolding processes.

28. The method for improving the surface gloss stability of an acrylonitrile-butadiene-styrene copolymer composition (ABS) according to claim 16, wherein,
A11 is styrene, and
A21 is styrene.

29. The method for improving the surface gloss stability of an acrylonitrile-butadiene-styrene copolymer composition (ABS) according to claim 20, wherein,
E11 is styrene;
E21 is styrene; and
E22 is acrylonitrile.

30. The acrylonitrile-butadiene-styrene copolymer composition (ABS) according to claim 22, wherein,
v-ABS is 11 to 70 wt. %, based on the acrylonitrile-butadiene-styrene copolymer composition (ABS);
r-ABS is 30 to 89 wt. %, based on the acrylonitrile-butadiene-styrene copolymer composition (ABS);
P is 0 to 10 wt.-%, based on the acrylonitrile-butadiene-styrene copolymer composition (ABS);
A11 is styrene;
A21 is styrene; and
A22 is acrylonitrile.

31. The acrylonitrile-butadiene-styrene copolymer composition (ABS) according to claim 23, wherein the at least one recycled acrylonitrile-butadiene-styrene copolymer composition (r-ABS) is a recycled material obtained from the recycling of post-consumer durable goods.

32. The acrylonitrile-butadiene-styrene copolymer composition (ABS) according to claim 24, wherein
E11 is styrene;
E21 is styrene; and
E22 is acrylonitrile.

33. The acrylonitrile-butadiene-styrene copolymer composition (ABS) according to claim 22, wherein,
v-ABS is 20 to 60 wt.-%, based on the acrylonitrile-butadiene-styrene copolymer composition (ABS);
r-ABS is 40 to 80 wt.-%, based on the acrylonitrile-butadiene-styrene copolymer composition (ABS); and
P is 0 to 5 wt.-%, based on the acrylonitrile-butadiene-styrene copolymer composition (ABS).
